(19) United States
(12) Patent Application Publication
(10) Pub. No.: US 2022/0333433 A1
(43) Pub. Date: Oct. 20, 2022

(54) LAMINATED VACUUM-INSULATED GLAZING ASSEMBLY

(71) Applicants: AGC GLASS EUROPE, Louvain-la-Neuve (BE); AGC INC., Chiyoda-Ku (JP); AGC FLAT GLASS NORTH AMERICA, INC., Alpharetta, GA (US); AGC VIDROS DO BRASIL LTDA, Sao Paulo (BR)

(72) Inventors: Julien JEANFILS, Corbais (BE); Abderrazek BEN TRAD, Gosselies (BE)

(73) Assignees: AGC GLASS EUROPE, Louvain-la-Neuve (BE); AGC INC., Chiyoda-Ku (JP); AGC FLAT GLASS NORTH AMERICA, INC., Alpharetta, GA (US); AGC VIDROS DO BRASIL LTDA, Sao Paulo (BR)

(21) Appl. No.: 17/312,499

(22) PCT Filed: Dec. 10, 2019
(86) PCT No.: PCT/EP2019/084343

§ 371 Date: Jun. 10, 2021

(30) Foreign Application Priority Data
Dec. 14, 2018 (EP) 18212518.7

(51) Int. Cl. E06B 3/66; E06B 3/67; E06B 3/663

(52) U.S. Cl. CPC E06B 3/6612; E06B 3/6715; E06B 3/66304; E06B 3/6617; E06B 3/66328

(57) ABSTRACT

A laminated vacuum insulating assembly extending along a plane, P, defined by a longitudinal axis, X, and a vertical axis, Z, including: a first glass pane with thickness Z1, an inner pane face and an outer pane face and a second glass pane with thickness, Z2, an inner pane face and an outer pane face; wherein the thicknesses are measured in the direction normal to the plane, with a set of discrete spacers positioned between the first and second glass panes, a hermetically bonding seal sealing the distance between the first and second glass panes over a perimeter thereof; and an internal volume, V, defined by the first and second glass panes and the set of discrete spacers and closed by the hermetically bonding seal and where there is an absolute vacuum of pressure of less than 0.1 mbar; and where the inner pane faces face the internal volume, V.

### 1. FIELD OF THE INVENTION

The invention relates to a vacuum-insulated glazing unit wherein one or more of the glass panes is (are) further laminated, in particular for safety, security and/or acoustic reasons.

### 2. BACKGROUND OF THE INVENTION

Vacuum-insulated glazing units are recommended because of their high-performance thermal insulation. A vacuum-insulated glazing unit is typically composed of at least two glass panes separated by an internal space in which a vacuum has been generated. In general, in order to achieve a high-performance thermal insulation (Thermal transmittance, U, being U<1.2 W/m²K) the absolute pressure inside the glazing unit is typically 0.1 mbar or less and generally at least one of the two glass panes is covered with a low-emissivity layer. To obtain such a pressure inside the glazing unit, a hermetically bonding seal is placed on the periphery of the two glass panes and the vacuum is generated inside the glazing unit by virtue of a pump. To prevent the glazing unit from caving in under atmospheric pressure (due to the pressure difference between the interior and exterior of the glazing unit), discrete spacers are placed between the two glass panes.

Vacuum-insulated glazing units are carefully dimensioned to resist to different external loads. A major load to be considered in dimensioning specifically vacuum-insulated glazing unit is the load induced by a temperature difference between exterior and interior environments. Therefore, it is critical to maintain its mechanical performance by controlling the level of thermal induced stress. Indeed, the glass pane facing the interior environment, takes up a temperature similar to the temperature of the interior environment and the glass pane facing the exterior environment, takes up a temperature similar to the temperature of the exterior environment. In most stringent weather conditions, the difference between the interior and exterior temperatures can reach 40° C. and more. The temperature difference between the interior and exterior environments may cause stress inside the glass panes and in some severe cases, it may lead to fracture the vacuum-insulated glazing.

For safety and security applications, in addition to the mechanical performance, it is necessary that the vacuum-insulated glazing unit meets the safety requirement as registered in European Standard Norm EN12600. European Standard Norm EN356 deals with security glazing designed to resist actions of force by delaying access of objects and/or persons to a protected space for a short period of time. It is well known in the art to use laminated glass to obtain such safety and security performance: two or more glass panes are bonded together by a durable plastic interlayer, which enables the glass to strongly resist penetration by impacting objects. If the glass would nevertheless break, it will tend to remain in its frame, minimizing the risk of injury from sharp edges and flying or falling glass particles. Therefore, laminated glass is usually used for applications in protection against explosions, protection against burglary, for bullet resistance, in glass floors or stairs, protection from fallout of broken glass from building facades, earthquake resistance, . . . .

EP 1 544 180 discloses a vacuum-insulated glazing unit wherein one of the glass panes has an outer surface bonded to a plate-shaped member via an adhesive layer to minimize distortions of reflected images while maintaining a low coefficient of heat transmission. WO97/24294 discloses a vacuum-insulated glazing unit to maintain high heat insulating properties while shielding the line of sight by adding on the exterior a coating film or by frosting the exterior surface.

However, none of the art addresses the technical problem maintaining the mechanical performance by controlling the level of induced thermal stress of vacuum-insulated glazing units, which have been further laminated, in particular to provide the additional benefit of safety, security and/or acoustic performance(s).

### 3. SUMMARY OF THE INVENTION

The present invention relates to a laminated vacuum insulating assembly extending along a plane, P, defined by a longitudinal axis, X, and a vertical axis, Z, and comprising:

i. a first glass pane having a thickness Z1, and having an inner pane face and an outer pane face and a second glass pane having a thickness, Z2, and having an inner pane face and an outer pane face; wherein the thicknesses are measured in the direction normal to the plane, P;

ii. a set of discrete spacers positioned between the first and second glass panes, maintaining a distance between the first and the second glass panes;
iii. a hermetically bonding seal sealing the distance between the first and second glass panes over a perimeter thereof;

iv. an internal volume, V, defined by the first and second glass panes and the set of discrete spacers and closed by the hermetically bonding seal and wherein there is an absolute vacuum of pressure of less than 0.1 mbar; and wherein the inner pane face faces the internal volume, V;

wherein the outer pane face of the first glass pane is laminated to m glass sheet by m polymer interlayer to form a laminated assembly; and/or the outer pane face of the second glass pane is laminated to n glass sheet by n polymer interlayer to form a laminated assembly; wherein the glass sheet has a sheet thickness, Zs, measured in the direction normal to the pane, P and wherein m is a positive integer greater than or equal to 0 (m≥0), n is a positive integer greater than or equal to 0 (n≥0) and the sum of the m and n integers is greater than or equal to 1 (m+n≥1). In a preferred embodiment, the present invention relates to a laminated vacuum insulated assembly wherein m+n equals 2, preferably equals 1 and/or wherein m equals 0.

Within the laminated vacuum insulated assembly, the cubic root of the sum of the sheet thicknesses, Zs, to the third power is equal to or lower than a maximum thickness value, Zmax,

$$( \sqrt[3]{{\sum }_{i = 1}^{m + n} {Zs}_{i}^{3}} \leq Z max )$$

wherein Zmax is calculated as per Equation A below, expressed in mm:

Zmax=5.78−3.4Ra−0.57(Ra−1.68)²+1.1(Z1+Z2)−0.26[(Z1+Z2)−12][Ra−1.68] (Equation A)

wherein Ra is the maximum value between a thickness ratio of the thickness of the first glass pane to the thickness of the second glass pane, Z1/Z2, and a thickness ratio of the thickness of the second glass pane to the thickness of the first glass pane, Z2/Z1.

In a preferred embodiment, the present invention relates to a laminated vacuum insulating assembly wherein the cubic root of the sum of the sheet thicknesses, Zs, to the third power, is equal to or lower than 125% of an optimum thickness value, Zopt,

$$( \sqrt[3]{{\sum }_{i = 1}^{m + n} {Zs}_{i}^{3}} \leq 1.25 Zopt ) ;$$

preferably is equal to or lower than the optimum thickness value, Zopt,

$$( \sqrt[3]{{\sum }_{i = 1}^{m + n} {Zs}_{i}^{3}} \leq Zopt )$$

wherein Zopt is calculated as per Equation B below, expressed in mm:

Zopt=2.54−1.42Ra−0.625(Ra−1.68)²+0.73(Z1+Z2)−0.12[(Z1+Z2)−12][Ra−1.68] (Equation B)

Preferably, the cubic root of the sum of the sheet thicknesses, Zs, to the third power, is equal to or greater than 2 mm, more preferably is equal to or greater than 3 mm. In a further preferred embodiment, the laminated VIG of the present invention is carefully dimensioned so that the cubic root of the sum of the sheet thicknesses, Zs, to the third power, is equal to or greater than 40% of the optimum thickness value, Zopt,:

$$\sqrt[3]{{\sum }_{i = 1}^{m + n} {Zs}_{i}^{3}} \geq 0.4 Zopt ;$$

and preferably is equal to or greater than 80% of the optimum thickness value, Zopt:

$$\sqrt[3]{{\sum }_{i = 1}^{m + n} {Zs}_{i}^{3}} \geq 0.8 Zopt .$$

The laminated vacuum insulating glazing will more preferably be configured so that the cubic root of the sum of the sheet thicknesses, Zs, to the third power, is comprised between 80% and 125% of the optimum thickness value, Zopt:

$$0.8 Zopt \leq \sqrt[3]{{\sum }_{i = 1}^{m + n} {Zs}_{i}^{3}} \leq 1.25 Zopt .$$

Within the laminated vacuum insulating assembly of the present invention, the thickness of the first glass pane, Z1, can be greater than the thickness of the second glass pane, Z2, preferably with a thickness ratio, Z1/Z2, equal to or greater than 1.10 (Z1/Z2≥1.10), preferably is equal to or greater than 1.30 (Z1/Z2≥1.30), more preferably equal to or greater than 1.55 (Z1/Z2≥1.10), more preferably comprised between 1.60 and 6.00 (1.60≤Z1/Z2≤6.00), even more preferably between 2.00 and 4.00 (2.00≤Z1/Z2≤4.00).

In a preferred embodiment, the present invention relates to a laminated vacuum insulating assembly, wherein the first glass pane has a coefficient of linear thermal expansion, CTE1, and the second glass pane has a coefficient of linear thermal expansion, CTE2, and wherein the absolute difference between CTE1 and CTE2 is at most 1.2 10⁻⁶/° C. (|CTE1−CTE2|≤1.2 10⁻⁶/° C.), preferably is at most 0.8 10⁻⁶/° C. (|CTE1−CTE2|≤0.8 10⁻⁶/° C.), more preferably at most 0.4 10⁻⁶/° C. (|CTE1−CTE2|≤0.4 10⁻⁶/° C.).

The laminated vacuum insulating assembly of the present invention preferably has a length, L, measured along the vertical axis, Z; equal to or greater than 500 mm, (L≥500 mm), preferably equal to or greater than 800 mm (L≥800 mm), more preferably equal to or greater than 1200 mm, (L≥1200 mm). Typically, the laminated vacuum insulating assembly has a width, W, measured along the longitudinal axis, X; equal to or greater than 300 mm, (W≥300 mm), preferably equal to or greater than 400 mm, (W≥400 mm), more preferably equal to or greater than 500 mm, (W≥500 mm).

Other aspects and advantages of the embodiments will become apparent from the following detailed description taken in conjunction with the accompanying drawings which illustrate, by way of example, the principles of the described embodiments.

### 4. BRIEF DESCRIPTION OF THE DRAWINGS

FIG. 1 shows a cross sectional view of a laminated vacuum insulated assembly according to one embodiment of the present invention, wherein the thickness of the first glass pane equals the thickness of the second glass pane, wherein the outer pane face of the second glass pane is laminated to a single glass sheet.

FIG. 2 shows a cross sectional view of a laminated vacuum insulated assembly according to a further embodiment of the present invention, wherein the thickness of the first glass pane is greater than the thickness of the second glass pane, wherein the outer pane face of the first glass pane has been laminated to two glass sheets and wherein the outer pane face of the second glass pane is laminated to a single glass sheet.

### 5. DETAILED DESCRIPTION OF THE INVENTION

It is an object of the present invention to provide a laminated vacuum insulated assembly which demonstrates high performing thermal insulation, at least maintains the mechanical performance of the VIG by not exceeding its initial level of stress induced by a temperature difference between interior and exterior environments, while providing the additional benefits of safety, security, anti-burglary and/or acoustics. Another object of the present invention is to improve the mechanical performance of the VIG by reducing the level of thermal induced stress by laminating one or more additional glass sheet(s) to the outer pane face of the first and/or second glass pane(s).

The object of the present invention relates to a “laminated vacuum insulated assembly” which comprises a vacuum insulated glazing hereinafter referred to as “VIG” and one or more laminated glass sheets. Such objet is hereinafter referred to as “laminated VIG”.

Glazings such as VIGs, are typically used to close partition separating a first space characterized by a first temperature, Temp1, from a second space defined by a second temperature, Temp2, wherein the Temp1 is lower than Temp2. The temperature of the interior space is typically from 20 to 25° C. whereas the temperature of the exterior space can extend from −20° C. in the winter to +35° C. in the summer. Therefore, the temperature difference between the interior space and the exterior space can typically reach more than 40° C. in severe conditions. The temperature of each glass pane of the laminated VIG, (T1, T2) will reflect the temperature of the corresponding space (Temp1, Temp2). If the VIG is positioned so that its first glass pane is facing the first space, the temperature of said first glass pane (T1) will reflect the temperature of the first space (Temp1) and the temperature of the second glass pane (T2) will reflect the temperature of the second space (Temp2) and vice-versa. Thermal induced stress occurs as soon as there is a temperature difference between the first glass pane (1 and T1) and the second glass pane (2 and T2) and increases with increasing differences between T1 and T2. The temperature difference (ΔT) is the absolute difference between the mean temperature T1 calculated for the first glass pane (1) and the mean temperature T2 calculated for the second glass pane (2). The mean temperature of a glass pane is calculated from numerical simulations known to the skilled people. Thermal induced stress becomes even more problematic—up to potential breaking the VIG, when such absolute temperature difference between the glass panes reaches 20° C. and becomes critical when such absolute temperature difference is higher than 30° C. and reaches 40° C. in severe conditions.

Therefore, a VIG is carefully dimensioned to resist to the thermal induced stress specific to its environment of use. The object of the present invention is to bring the additional performances of safety, security, anti-burglary and/or acoustics by lamination of one or more of the glass panes of the VIG while maintaining and even reducing the level of thermal induced stress. It has been surprisingly found that by carefully designing the thickness of the additional glass sheet(s) that will be laminated to the one or both of the outer pane face(s) of the VIG glass panes, the benefit of safety, security, and/or acoustics can be added without impairing and/or even improving its mechanical resistance to thermal induced stress.

The laminated vacuum insulated assembly encompasses a vacuum-insulated glazing unit which typically comprises a first glass pane and a second glass pane that are associated together by way of set of discrete spacers that holds said panes a certain distance apart, typically in the range of between 50 μm and 1000 μm, preferably between 50 μm and 500 μm and more preferably between 50 μm and 150 μm. Between said glass panes, an internal space comprising at least one first cavity, in which cavity there is a vacuum of absolute pressure of less than 0.1 mbar, is closed with a peripheral hermetically bonding seal placed on the periphery of the glass panes around said internal space.

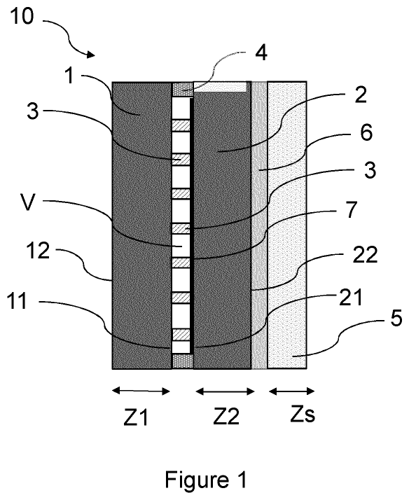

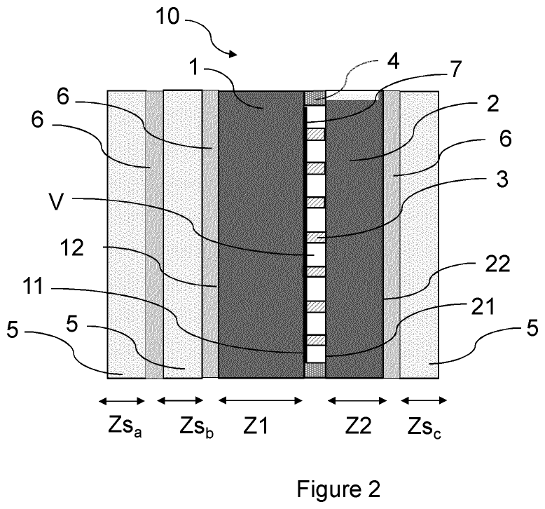

As illustrated in FIGS. 1 and 2, the laminated vacuum insulating assembly (10) of the present invention extends along a plane, P, defined by a longitudinal axis, X, and a vertical axis, Z and comprises:

i. a first glass pane (1) having a thickness Z1, and having an inner pane face (11) and an outer pane face (12) and a second glass pane (2) having a thickness, Z2, and having an inner pane face (21) and an outer pane face (22). The thicknesses are measured in the direction normal to the plane, P;

ii. a set of discrete spacers (3) positioned between the first and second glass panes, maintaining a distance between the first and the second glass panes;

iii. a hermetically bonding seal (4) sealing the distance between the first and second glass panes over a perimeter thereof;

iv. an internal volume, V, defined by the first and second glass panes and the set of discrete spacers and closed by the hermetically bonding seal and wherein there is an absolute vacuum of pressure of less than 0.1 mbar; and wherein the inner pane face faces the internal volume, V.

Within the present invention, the outer pane face (12) of the first glass pane (1) is laminated to m glass sheet (5) by m polymer interlayer (6) to form a laminated assembly and/or the outer pane face (22) of the second glass pane (2) is laminated to n glass sheet (5) by n polymer interlayer (6) to form a laminated assembly. The integer m is a positive integer greater than or equal to 0 (m≥0). The integer n is a positive integer greater than or equal to 0 (n≥0). The sum of the m and n integers is greater than or equal to 1 (m+n≥1). Each glass sheet has a sheet thickness, Zs, measured in the direction normal to the pane, P.

### Thermal Induced Stress

Thermal induced stress (σΔT) is the stress induced on the glass panes of the VIG when said glass panes are exposed to a temperature difference between the interior and the exterior environments. The thermal induced stress is the combination of shear and bending stresses across the thickness of the VIG. The thermal induced stress profile across a VIG is known in the art as per Timoshenko in the article “Timoshenko, S., Analysis of Bi-metal Thermostats. JOSA, 1925. 11(3): p. 233-255” used to calculate stresses in bimetallic strip, which can be easily extended to vacuum insulating glazings.

The thermal induced stress profile as per Timoshenko can easily be extended further to consider laminated vacuum insulating glazings. For laminated VIG assemblies, the assumption is made that the shear transfer coefficient of the polymer interlayer equals to 0. This assumption widely accepted in the art, is based on the slow variations of temperature observed when a VIG is exposed to the daily temperature differences of its environment. Therefore, only bending stress is considered within the additional glass sheet(s) laminated to the outer glass pane of the VIG.

For each laminated VIG configuration, such stress profile can be calculated and provides the value of the maximal tensile stress on the VIG external surface; i.e. the outer pane face of the first or second glass panes (12 or 22). This maximal tensile stress on the VIG external surface is the thermal induced stress that will be considered in the present invention.

The above described analytical solution allows to calculate the thermal induced stress for all VIG configurations. The thermal induced stress for a non-laminated VIG construction having a first glass pane of a given thickness Z1 and a second glass pane of a given thickness Z2, is calculated and its maximal tensile stress on its external surface will be considered as the referenced thermal induced stress value that should not be exceeded by the corresponding laminated VIG.

Similarly, for a given VIG construction, the above described analytical solution allows to calculate thermal induced stresses for different lamination configurations of increasing thickness, i.e. wherein the VIG construction is laminated to one or more additional glass sheet(s) of increasing thicknesses. It has been surprisingly found that for a given VIG construction, the thermal induced stress values calculated for different lamination configurations always encompass a lowest thermal induced stress value.

It has been further surprisingly found that a correlation can be established between the referenced thermal induced stress value or between such lowest thermal stress value, and the thickness of the additional glass sheets. To the referenced thermal induced stress value corresponds a maximum thickness value, Zmax that should not be exceeded by the cubic root of the sum of the sheet thicknesses of all additional laminated glass sheet(s), Zs, to the third power. Such maximum thickness value is calculated as per Equation A below. Similarly, to the lowest thermal induced stress value corresponds an optimum thickness value, Zopt that should be approached as much as possible to provide improved resistance to thermal induced stress, by the cubic root of the sum of the sheet thicknesses of all additional laminated glass sheet(s), Zs, to the third power. Such optimum thickness value, Zopt, is calculated as per Equation B below. The present invention is based on this surprising finding that for any laminated VIG configuration having any given first glass thickness, Z1, and any given second glass thickness, Z2, whatever the number of additional glass sheet(s), whatever the singular glass sheet thickness and whatever their position on the VIG, the thermal induces stress data always provide a lowest thermal induced stress value to which corresponds an optimum thickness value.

Therefore, a VIG can be laminated without impairing its mechanical performance as long as the cubic root of the sum of the sheet thicknesses, Zs, to the third power is equal to or lower than the maximum thickness value, Zmax and preferably so that the cubic root of the sum of the sheet thicknesses, Zs, to the third power is comprised between 40%, preferably 80% and 125%, preferably 100% of the optimum thickness value (Zopt) to reduce the level of thermal induced stress.

Therefore, in the present invention, the lamination of additional glass sheet(s) to the outer pane faces of the glass pane(s) of the vacuum-insulating glazing unit, is carefully configured so that the cubic root of the sum of the sheet thicknesses, Zs, to the third power is equal to or lower than the maximum thickness value, Zmax,

$$\sqrt[3]{{\sum }_{i = 1}^{m + n} {Zs}_{i}^{3}} \leq Zmax$$

wherein Zmax is calculated as per Equation A below, expressed in mm:

Zmax=5.78−3.4Ra−0.57(Ra−1.68)²+1.1(Z1+Z2)−0.26[(Z1+Z2)−12][Ra−1.68] (Equation A)

wherein Ra is the maximum value between a thickness ratio Z1/Z2 of the thickness of the first glass pane, Z1, to the thickness of the second glass pane Z2 and a thickness ratio Z2/Z1 of the thickness of the second glass pane, Z2, to the thickness of the first glass pane Z1.

In one embodiment, the VIG of the present invention can be laminated by a single glass sheet to one glass pane. For example and as illustrated in FIG. 1, the outer pane face of the first glass pane (12) is not laminated (m=0) while the outer pane face of the second glass pane (22) is laminated to a single glass sheet (5) (n=1) having a thickness, Zs. In this instance, Zs is required to be equal to or lower than the maximum thickness value, Zmax (Zs≤Zmax).

In another configuration, the outer pane face of the first glass plane can be laminated to two glass sheets (5a and 5b) (m=2) and the outer pane face of the second glass sheet is not laminated (n=0). The first glass sheet (5a) has a sheet thickness, Zsa and the second glass sheet (5b) has a sheet thickness Zsb. In another configuration of the present invention, the outer pane face of the first glass pane can be laminated to a single glass sheet (5a) (m=1) having a thickness, Zsa and the outer pane face of the second glass pane can be laminated to a single glass sheet (5b) (n=1) having a thickness, Zsb. In both configurations, the sheet thicknesses Zsa and Zsb can be the same, (Zsₐ=Zs_{b}) or different (Zsₐ≠Zs_{b}); and the cubic root of the sum of the sheet thicknesses, Zs, to the third power

$$( \sqrt[3]{{Zs}_{a}^{3} + {Zs}_{b}^{3}}$$

is required to be equal to or lower than the maximum thickness value, Zmax,

$$( \sqrt[3]{{Zs}_{a}^{3} + {Zs}_{b}^{3}} \leq Zmax ) .$$

In a further configuration as illustrated in FIG. 2, the outer pane face of the first glass pane (12) can be laminated to two glass sheets (5ₐ, 5_{b}) (m=2) having respectively a sheet thickness Zsₐ and Zs_{b} and the outer pane face of the second glass pane (22) can be laminated to a single glass sheet (5_{c}) (n=1) having a thickness, Zs_{c}. Each sheet thicknesses Zsₐ, Zs_{b} and Zs_{c} can be independently the same, (Zsₐ=Zs_{b}=Zs_{c} or Zsₐ=Zs_{b} and/or Zsₐ=Zs_{c} and/or Zs_{b}=Zs_{c}) or different (Zsₐ≠Zs_{b} and/or ZsₐZs_{c} and/or Zs_{b}≠Zs_{c}). In this instance, the cubic root of the sum of the sheet thicknesses, Zs, to the third power

$$\sqrt[3]{{Zs}_{a}^{3} + {Zs}_{b}^{3} + {Zs}_{c}^{3}}$$

is required to be equal to or lower than the maximum thickness value, Zmax,

$$( \sqrt[3]{{Zs}_{a}^{3} + {Zs}_{b}^{3} + {Zs}_{c}^{3}} \leq Zmax ) .$$

In a preferred embodiment, the laminated VIG of the present invention is carefully dimensioned so that the cubic root of the sum of the sheet thicknesses, Zs, to the third power, is equal to or lower than 125% of an optimum thickness value, Zopt,

$$\sqrt[3]{{\sum }_{i = 1}^{m + n} {Zs}_{i}^{3}} \leq 1.25 Zopt ;$$

preferably equal to or lower than the optimum thickness value, Zopt,

$$\sqrt[3]{{\sum }_{i = 1}^{m + n} Z {s}_{i}^{3}} \leq Zopt ,$$

wherein Zopt is calculated as per Equation B below, expressed in mm:

Zopt=2.54−1.42Ra−0.625(Ra−1.68)²+0.73(Z1+Z2)−0.12[(Z1+Z2)−12][Ra−1.68] (Equation B)

wherein Ra is the maximum value between a thickness ratio of the thickness of the first glass pane to the thickness of the second glass pane, Z1/Z2, and a thickness ratio of the thickness of the second glass pane to the thickness of the first glass pane, Z2/Z1.

Preferably, the laminated vacuum insulating glazing unit of the present invention will be dimensioned so that the cubic root of the sum of the sheet thicknesses, Zs, to the third power, is equal to or greater than 2 mm:

$$\sqrt[3]{{\sum }_{i = 1}^{m + n} Z {s}_{i}^{3}} \geq 2 mm ;$$

preferably is equal to or greater than 3 mm:

$$\sqrt[3]{{\sum }_{i = 1}^{m + n} Z {s}_{i}^{3}} \geq 3 mm .$$

In a further preferred embodiment, the laminated VIG of the present invention is carefully dimensioned so that the cubic root of the sum of the sheet thicknesses, Zs, to the third power, is equal to or greater than 40% of an optimum thickness value, Zopt,:

$$\sqrt[3]{{\sum }_{i = 1}^{m + n} Z {s}_{i}^{3}} \geq 0.4 Zopt ;$$

and preferably is equal to or greater than 80% of an optimum thickness value, Zopt,:

$$\sqrt[3]{{\sum }_{i = 1}^{m + n} Z {s}_{i}^{3}} \geq 0.8 Zopt .$$

In a preferred embodiment, the laminated VIG of the present invention is carefully dimensioned so that the cubic root of the sum of the sheet thicknesses, Zs, to the third power, is comprised between 80% and 125% of an optimum thickness value, Zopt,:

$$0.8 Zopt \leq \sqrt[3]{{\sum }_{i = 1}^{m + n} Z {s}_{i}^{3}} \leq 1.25 Zopt .$$

The “cubic root of the sum of the sheet thicknesses, Zs, to the third power”, will be referred herein after as “sheet equivalent thickness”.

It has been found further that when the first and second glass panes of similar coefficient of linear thermal expansion (CET) are used to design the laminated VIG of the present invention, it provides better resistance to thermal induced stress. Indeed, it has been found that configuring a VIG with a first and second glass panes having similar—if not identical, CET, avoids to add initial thermal induced stress between the first and second glass panes during the heating and cooling steps of the manufacturing process. Therefore, in a preferred embodiment of the present invention, the first glass pane has a coefficient of linear thermal expansion, CET1, and the second glass pane has a coefficient of linear thermal expansion, CET2, whereby the absolute difference between CET1 and CET2 is at most 1.2 10⁻⁶/C (|CET1−CET2|≤1.2 10⁻⁶/° C.); preferably is at most 0.80 10⁻⁶/° C. (|CET1−CET2|≤0.80 10⁻⁶/° C.), more preferably is at most 0.40 10⁻⁶/° C. (|CET1−CET2|≤0.40 10⁻⁶/° C.). Ideally, the first and second glass panes have the same coefficient of linear thermal expansion. The term “coefficient of thermal expansion” (CTE) is a measure of how the size of an object changes with a change in temperature and is mean measure over a temperature range of 0° C. to 100° C., at a constant pressure.

The laminate assembly(ies) within the laminated VIG of the present invention typically comprise from 1 to 4 additional glass sheet(s) and corresponding additional layers of polymer interlayer. However, it is preferred to laminate to the outer pane face of the first and/or second glass pane with 1 to 2 glass sheet(s). Preferably the sum of the m and n integers is equal to or lower than 2 (m+n≤2), more preferably the sum of the m and n integers is equal to 1 (m+n=1). In another preferred embodiment, the m integer equals to 0 (m=0). However, depending on the specific use of the laminated VIG of the present invention for high safety, high security and/or high acoustic performance(s), a higher number of glass sheets, typically up to 6 glass sheets, can be used on each glass panes of the VIG.

As illustrated in FIG. 1, single or multiple glass sheets can be laminated to one side only of the VIG, i.e. only to the outer pane face of the first glass pane or of the second glass pane (m=0 or n=0). Single sided laminated VIGs will typically be used when only one technical advantage of safety or security or acoustics is expected. In another embodiment as illustrated in FIG. 2, single or multiple glass sheets can be laminated to the outer pane face of the first and of the second glass panes (m≥1 and n≥1). Double sided laminated VIGs will typically be used when several safety, security and/or acoustics technical properties are required.

When several glass sheet are laminated to the outer pane face of the first and/or second glass pane of the VIG of the present invention, each glass sheet has a thickness, Zs, which can be identical or different. The sheet thicknesses are measured in the direction normal to the plane, P.

In one embodiment, the thickness of the first glass pane, Z1, is identical to the thickness of the second glass pane, Z2, (Z1=Z2) as illustrated in FIG. 1. In another embodiment, the thickness of the second glass pane, Z1, is greater or lower than the thickness of the second glass pane, Z2 (Z1>Z2 or Z1<Z2) as illustrated in FIG. 2 wherein Z1 is greater than Z2.

It has been surprisingly further found that the laminated VIG wherein the thickness of the first glass pane is different from the thickness of the second glass pane (Z1≠Z2)—when carefully dimensioned, can provide better resistance to thermal induced stress. Therefore, in one embodiment, the laminated VIG of the present invention is dimensioned so that the thickness ratio, Z1/Z2, of the thickness of the first glass pane, Z1, to the thickness of the second glass pane, Z2, is equal to or greater than 1.10 (Z1/Z2≥1.10), preferably is equal to or greater than 1.30 (Z1/Z2≥1.30), preferably is equal to or greater than 1.55 (Z1/Z2≥1.55), more preferably is comprised between 1.60 and 6.00 (1.60≤Z1/Z2≤6.00), even more preferably between 2.00 and 4.00 (2.00≤Z1/Z2≤4.00). In another embodiment, the laminated VIG of the present invention is dimensioned so that the thickness ratio, Z2/Z1, of the thickness of the second glass pane, Z2, to the thickness of the first glass pane, Z1, is equal to or greater than 1.10 (Z2/Z1≥1.10), preferably is equal to or greater than 1.30 (Z1/Z2≥1.30), more preferably is equal to or greater than 1.55 (Z2/Z1≥1.55), more preferably is comprised between 1.60 and 6.00 (1.60≥Z2/Z1≤6.00), even more preferably between 2.00 and 4.00 (2.00≤Z2/Z1≤4.00). It has been found that the higher the Z1/Z2 ratio or the Z2/Z1 ratio, the better it is for achieving higher mechanical performances.

The thickness of the first and/or second glass panes, Z1, Z2, of the VIG, are typically equal to or greater than 2 mm (Z1, Z2≥2 mm), preferably are equal to or greater to 3 mm, (Z1, Z2≥3 mm), more preferably equal to or greater to 4 mm, (Z1, Z2≥4 mm) more preferably equal to or greater to 6 mm, (Z1, Z2≥6 mm). Typically, the thickness of the first and second glass panes, will be not more than 12 mm, preferably not more than 10 mm, more preferably not more than 8 mm.

The thickness of the glass sheet, Zs, is typically equal to or greater than 0.5 mm (Zs≥0.5 mm), preferably is equal to or greater to 1 mm, (Zs≥1 mm), more preferably is equal to or greater to 2 mm, (Zs≥2 mm), even more preferably is equal to or greater to 3 mm, (Zs≥3 mm). Typically, the thickness of the glass sheet, will be not more than 12 mm, preferably not more than 10 mm, more preferably not more than 8 mm, even more preferably not more than 6 mm.

Preferred configurations for the VIG to be used in the present invention will comprise first glass and second glass panes of the following thicknesses as summarized in the table A below:

| | First glass pane - | Second glass pane - |
|---|---|---|
| Table A | thickness Z1 | thickness Z2 |
| (1) | Z1 = 3 mm | Z2 = 3 mm |
| (2) | Z1 = 6 mm | Z2 = 3 mm |
| (3) | Z1 = 4 mm | Z2 = 4 mm |
| (4) | Z1 = 6 mm | Z2 = 4 mm |
| (5) | Z1 = 5 mm | Z2 = 5 mm |
| (6) | Z1 = 6 mm | Z2 = 6 mm |
| (7) | Z1 = 8 mm | Z2 = 8 mm |

Typically, one or two glass sheet(s) of a glass sheet thickness, Zs, of 3 mm, 4 mm, 5 mm or 6 mm will be laminated to the outer pane face of the first and/or second glass pane(s).

The present invention relates to a laminated VIG extending along a plane, P, defined by a longitudinal axis, X, and a vertical axis, Z, and having a width, W, measured along the longitudinal axis, X, and a length, L, measured along the vertical axis, Z. In a preferred embodiment of the present invention, the length, L, of the asymmetric VIG of the present invention, is equal to or greater than 500 mm, (L≥500 mm), more preferably is equal to or greater than 800 mm, (L≥800 mm), even more preferably equal to or greater than 1200 mm, (L≥1200 mm). In a further preferred embodiment, the width of the asymmetric VIG of the present invention, W, is equal to or greater than 300 mm, (W≥300 mm), preferably is equal to or greater than 500 mm, (W≥500 mm), more preferably is equal to or greater than 800 mm, (W≥800 mm). Indeed, the larger the laminated VIG of the present invention is, the more is it exposed to the external loads and hence, the more the laminated VIG of the present invention needs to resist to thermal induced stress.

### Glass Panes and Sheets

The first glass pane, the second glass pane and the glass sheet of the laminated VIG of present invention can be chosen among float clear, extra-clear or colored glass. The term “glass” is herein understood to mean any type of glass or equivalent transparent material, such as a mineral glass or an organic glass. The mineral glasses used may be irrespectively one or more known types of glass such as soda-lime-silica, aluminosilicate or borosilicate, crystalline and polycrystalline glasses. The glass panes and/or sheet(s) can be obtained by a floating process, a drawing process, a rolling process or any other process known to manufacture a glass pane starting from a molten glass composition. The glass panes and/or sheet(s) can optionally be edge-ground. Edge grinding renders sharp edges into smooth edges which are much safer for people who could come in contact with the vacuum-insulating glazing unit, in particular with the edge of the glazing. Preferably, the glass panes and/or sheet(s) according to the invention are of soda-lime-silica glass, aluminosilicate glass or borosilicate glass. Preferably—for reasons of lower production costs, the glass panes are panes of soda-lime-silica glass as well as and the glass sheet(s). Typically, the first and second glass panes of the present invention are annealed glass panes.

In one embodiment, to provide a laminated VIG with higher mechanical performances and/or to improve further the safety of the VIG, it can be contemplated to physically or chemically pre-stress the first and/or second glass pane(s) of the present invention. In this instance, it is required that both the first and second glass panes are treated by the same pre-stress treatment to provide the same resistance to thermal induced load. Therefore, if pre-stress treatment occurs on the glass panes, then it requires that the first glass pane and the second glass pane are both heat strengthened glass panes, or that the first glass pane and the second glass pane are both thermally toughened glass panes or that the first glass pane and the second glass pane are both chemically strengthened glass panes.

Heat strengthened glass is heat treated using a method of controlled heating and cooling which places the glass surface under compression and the glass core under tension. This heat treatment method delivers a glass with a bending strength greater than annealed glass but less than thermally toughened safety glass.

Thermally toughened safety glass is heat treated using a method of controlled high temperature heating and rapid cooling which puts the glass surface under compression and the glass core under tension. Such stresses cause the glass, when impacted, to break into small granular particles instead of splintering into jagged shards. The granular particles are less likely to injure occupants or damage objects.

The chemical strengthening of a glass article is a heat induced ion-exchange, involving replacement of smaller alkali sodium ions in the surface layer of glass by larger ions, for example alkali potassium ions. Increased surface compression stress occurs in the glass as the larger ions “wedge” into the small sites formerly occupied by the sodium ions. Such a chemical treatment is generally carried out by immerging the glass in an ion-exchange molten bath containing one or more molten salt(s) of the larger ions, with a precise control of temperature and time. Aluminosilicate-type glass compositions, such as for example those from the products range DragonTrail® from Asahi Glass Co. or those from the products range Gorilla® from Corning Inc., are also known to be very efficient for chemical tempering.

The additional glass sheet(s) used within the laminated VIG of the present invention can optionally and independently be pre-stress glass sheets.

Preferably, the composition for the first glass pane, the second glass panes and/or the glass sheet of the laminated VIG of the present invention comprises the following components in weight percentage, expressed with respect to the total weight of glass (Comp. A). More preferably, the glass composition (Comp. B) is a soda-lime-silicate-type glass with a base glass matrix of the composition comprising the following components in weight percentage, expressed with respect to the total weight of glass.

| | Comp. A | Comp. B |
|---|---|---|
| SiO2 | 40-78% | 60-78 wt % |
| Al2O3 | 0-18% | 0-8 wt %, pref 0-6 wt % |
| B2O3 | 0-18% | 0-4 wt %, pref 0-1 wt % |
| Na2O | 0-20% | 5-20 wt %, pref 10-20 wt % |
| CaO | 0-15% | 0-15 wt %, pref 5-15 wt % |
| MgO | 0-10% | 0-10 wt %, pref 0-8 wt % |
| K2O | 0-10% | 0-10 wt % |
| BaO | 0-5% | 0-5 wt %, pref 0-1 wt %. |

Other preferred glass compositions for the first glass pane, second glass panes and/or the glass sheet of the laminated VIG unit of the present invention, comprises the following components in weight percentage, expressed with respect to the total weight of glass:

| Comp. C | Comp. D | Comp. E |
|---|---|---|
| 65 ≤ SiO2 ≤ 78 wt % | 60 ≤ SiO2 ≤ 78% | 65 ≤ SiO2 ≤ 78 wt % |
| 5 ≤ Na2O ≤ 20 wt % | 5 ≤ Na2O ≤ 20% | 5 ≤ Na2O ≤ 20 wt % |
| 0 ≤ K2O < 5 wt % | 0.9 < K2O ≤ 12% | 1 ≤ K2O < 8 wt % |
| 1 ≤ Al2O3 < 6 wt %, | 4.9 ≤ Al2O3 ≤ 8% | 1 ≤ Al2O3 < 6 wt % |
| pref 3 < Al2O3 ≤ 5% | | |
| 0 ≤ CaO < 4.5 wt % | 0.4 < CaO < 2% | 2 ≤ CaO < 10 wt % |
| 4 ≤ MgO ≤ 12 wt % | 4 < MgO ≤ 12% | 0 ≤ MgO ≤ 8 wt % |
| (MgO/(MgO + CaO)) ≥ | | K2O/(K2O + Na2O): |
| 0.5, pref 0.88 ≤ | | 0.1-0.7. |
| [MgO/(MgO + CaO)] < 1. | | |

In particular, examples of base glass matrixes for the composition according to the invention are described published in POT patent applications WO2015/150207A1, WO2015/150403A1 WO2016/091672 A1, WO2016/169823A1 and WO2018/001965 A1.

The glass panes can be of the same dimensions or of different dimensions and form thereby a stepped VIG. In a preferred embodiment of the present invention, the first and the second glass panes (1, 2) comprise first and second peripheral edges, respectively and wherein the first peripheral edges are recessed from the second peripheral edges or wherein the second peripheral edges are recessed from the first peripheral edges. The peripheral edges of the glass sheets (5) are aligned with the peripheral edges of the glass pane to which it is laminated. This configuration allows to reinforce the strength of the hermetically bonding seal.

### Polymer Interlayer

The polymer interlayer to be used in the present invention typically comprises a material selected from the group consisting ethylene vinyl acetate (EVA), polyisobutylene (PIB), polyvinyl butyral (PVB), polyurethane (PU), polyvinyl chlorides (PVC), polyesters, copolyesters, polyacetals, cyclo olefin polymers (COP), ionomer and/or an ultraviolet activated adhesive, and others known in the art of manufacturing glass laminates. Blended materials using any compatible combination of these materials can be suitable as well. In a preferred embodiment, the polymer interlayer comprises a material selected from the group consisting of ethylene vinyl acetate, and/or polyvinyl butyral. More preferably, the polymer interlayer comprises a material capable of being processed at lower pressure. The polymer interlayer acts as a “bonding interlayer” since the polymer interlayer and the glass pane form a bond that results in adhesion between the glass pane and the polymer interlayer.

For practical reasons, the polymer interlayer used to form the laminate assembly (ies) is typically the same material between each glass panes and glass sheets. However, it could be contemplated to use different materials for the different polymer interlayers within the laminated VIG of the present invention.

In a preferred embodiment, the polymer interlayer to be used in the present invention is a transparent or translucent polymer interlayer. However, for decorative applications, the polymer interlayer may be colored or patterned.

Typical thicknesses (measured in the direction normal to the plane, P) for the polymer interlayer are 0.15 mm to 3.5 mm, preferably 0.30 mm to 1.75 mm, more preferably from 0.5 mm to 1.75 mm. Usual commercially available polymer films are polyvinyl butyral (PVB) layers of 0.38 mm and 0.76 mm, 1.52 mm, 2.28 m and 3.04 mm. To achieve the desired thickness, one or more of those films can be used.

Reinforced acoustic insulation can be provided by the laminated VIG of the present invention wherein a polymer interlayer with specific acoustic performance, such as specific PVBs, is used: e.g. Saflex® acoustic PVB interlayer from Eastman or Trisofol® acoustic PVB layer from Kuraray.

It has been surprisingly found that a vacuum insulating glazing and a laminated VIG as per invention, comprising a first glass pane of a thickness, Z1, and a second glass pane of a thickness, Z2, provides an acoustic performance similar to the acoustic performance of a monolithic glazing of the same overall thickness (Z1+Z2) and an acoustic performance substantially superior to a double insulating glazing having a first glass pane of a thickness, Z1 and a second glass pane of a thickness, Z2.

### Partition

The laminated VIG of the present invention is typically used to close an opening within a partition such as in general-purpose glazing units, a build wall automotive glazing units or architectural glazing units, appliances . . . . This partition separates an exterior space from an interior space, typically a partition separating the exterior space from the interior space of a building.

In the configuration wherein the laminated VIG of the present invention is characterized by a thickness ratio Z1/Z2 equal to or greater than 1.10 (Z1/Z2≥1.10), then such VIG will preferably close an opening of a partition separating a first space with a first temperature, Temp1, from a second space with a second temperature, Temp2, wherein Temp1 is lower than Temp2 and wherein the first glass pane is facing the first space.

The present invention also relates to the use of a laminated vacuum insulated assembly as defined above, to close the opening of a partition separating an exterior space from an interior space.

### Multiple Insulating Glazing

In another embodiment of the present invention, the present invention also applies to any type of glazing unit comprising glass panes (two, three or more) bounding insulating or non-insulating internal spaces (also called multiple glazing units) provided that a partial vacuum is generated in at least one of these internal spaces.

In one embodiment, to improve further the mechanical performances of the VIG of the present invention, a third additional glass pane can be coupled to at least one of the outer pane faces (12 and/or 22) of the first and/or second glass pane, along the periphery of the VIG via a peripheral spacer bar, also known as a spacer window profile, creating in insulating cavity sealed by a peripheral edge seal. Said peripheral spacer bar maintained a certain distance between the third glass pane and the outer pane face of the first glass pane. Typically said spacer bar comprises a desiccant and has typically a thickness comprised between 6 mm to 24 mm, preferably 9 to 15 mm. In general, said second internal volume is filled with a predetermined gas selected from the group consisting of air, dry air, argon (Ar), krypton (Kr), xenon (Xe), sulfur hexafluoride (SF6), carbon dioxide or a combination thereof. Said predetermined gas are effective for preventing heat transfer and/or may be used to reduce sound transmission. In a preferred embodiment, such this third additional glass pane will be coupled to the first or second glass pane of a laminated VIG wherein said first or second glass pane is not laminated, i.e. wherein m=0 or n=0. Preferably, a third additional glass pane coupled to the VIG of the present invention will be used to close a partition separating an interior space from the external environment and whereby such third additional glass pane will be located to face the external environment.

The person skilled in the art realizes that the present invention by no means is limited to the preferred embodiments described above. On the contrary, many modifications and variations are possible within the scope of the appended claims. It is further noted that the invention relates to all possible combinations of features, and preferred features, described herein and recited in the claims.

Preferably, the present invention will not comprise the specific embodiment wherein the thickness of the first glass pane, Z1, is equal to or greater to than 6 mm, (Z1≥6 mm), wherein the thickness ratio, Z1/Z2, of the thickness of the first glass pane, Z1, to the thickness of the second glass pane, Z2, is equal to or greater than 1.10 (Z1/Z2≥1.10), wherein the outer plane face of the first glass pane is not laminated to a glass sheet by at least one polymer interlayer forming a laminated assembly, i.e. m equals 0 (m=0) and wherein the outer pane face of the second glass pane is laminated to at least one glass sheet by at least one polymer interlayer (n=1) forming a laminated assembly wherein the glass sheet has a thickness, Zs, equal to or greater than 0.5 mm (Zs≥0.5 mm).

Preferably, the present invention will not comprise the specific embodiment wherein the thickness of the first glass pane, Z1, equals 8 mm, wherein the thickness of the second glass pane, Z2, equals 4 mm, wherein the outer plane face of the first glass pane is not laminated to a glass sheet by at least one polymer interlayer forming a laminated assembly, i.e. m equals 0 (m=0) and wherein the outer pane face of the second glass pane is laminated to one glass sheet by one polymer interlayer (n=1) forming a laminated assembly wherein the said glass sheet has a thickness, Zs, equal to 2 mm. Preferably, the present invention will not comprise the specific embodiment wherein the thickness of the first glass pane, Z1, equals 6 mm, wherein the thickness of the second glass pane, Z2, equals 3 mm, wherein the outer plane face of the first glass pane is not laminated to a glass sheet by at least one polymer interlayer forming a laminated assembly, i.e. m equals 0 (m=0) and wherein the outer pane face of the second glass pane is laminated to one glass sheet by one polymer interlayer (n=1) forming a laminated assembly wherein the said glass sheet has a thickness, Zs, equal to 2 mm.

### Coating

In some embodiment of the present invention, films such as low emissivity films, solar control films (a heat ray reflection films), anti-reflective films, anti-fog films, preferably a heat ray reflection film or a low emissivity film, can be provided on at least one of the inner pane faces (11, 21) and/or outer pane faces (12, 22) of the first and/or second glass panes (1, 2) of the laminated VIG (10). In a preferred embodiment of the present invention such as shown in FIGS. 1 and 2, the inner pane faces (11, 21) of the first or second glass pane (1, 2) of the laminated VIG is provided with a heat ray reflection film or a low-E film (7).

In the preferred embodiment wherein the laminated VIG is placed to close an opening within a partition, whereby the first glass pane (1) is facing the exterior environment, the first outer pane face (12) may be provided with a low-E film for reducing the formation of condensation on the glass surface. In such embodiment, it is preferred that low-E film or a heat ray reflection film is provided on at least one of the inner face pane of the first and second glass panes (11 and/or 21).

In another preferred embodiment, films can be added to the additional glass sheet(s). In particular, at least a heat ray reflection film or a low-E film may be provided on at least one surface of the glass sheet forming the laminated VIG assembly, for improving the emissivity performances.

Glass panes with electrochromic, thermochromic, photochromic or photovoltaic elements are also compatible with the present invention.

### Spacers

As depicted in FIGS. 1 and 2, the vacuum-insulated glazing unit of the present invention comprises a plurality of discrete spacers (3), also referred to as pillars, sandwiched between the first and second glass panes (1, 2) so as to maintain the internal volume, V. As per invention, the discrete spacers are positioned between the first and second glass panes, maintaining a distance between the first and the second glass panes and forming an array having a pitch, A, comprised between 10 mm and 100 mm (10 mm≤λ≤100 mm). By pitch, it is meant the interval between the discrete spacers. In a preferred embodiment, the pitch is comprised between 20 mm and 80 mm (20 mm≤λ≤80 mm), more preferably between 20 mm and 50 mm (20 mm≤λ≤50 mm). The array within the present invention is typically a regular array based on an equilateral triangular, square or hexagonal scheme, preferably based on a square scheme.

The discrete spacers can have different shapes, such as cylindrical, spherical, filiform, hourglass, C-shaped, cruciform, prismatic shape . . . . It is preferred to use small pillars, i.e. pillars having in general a contact surface to the glass pane, defined by its external circumference, equal to or lower than 5 mm², preferably equal to or lower than 3 mm², more preferably equal to or lower than 1 mm². These values may offer a good mechanical resistance whilst being aesthetically discrete. The discrete spacers are typically made of a material having a strength endurable against pressure applied from the surfaces of the glass panes, capable of withstanding high-temperature process such as burning and baking, and hardly emitting gas after the glass pane is manufactured. Such a material is preferably a hard metal material, quartz glass or a ceramic material, in particular, a metal material such as iron, tungsten, nickel, chrome, titanium, molybdenum, carbon steel, chrome steel, nickel steel, stainless steel, nickel-chromium steel, manganese steel, chromium-manganese steel, chromium-molybdenum steel, silicon steel, nichrome, duralumin or the like, or a ceramic material such as corundum, alumina, mullite, magnesia, yttria, aluminum nitride, silicon nitride or the like.

### Hermetically Bonding Seal

As shown in FIGS. 1 and 2, the internal volume, V, delimited between the glass panes (1, 2) of the vacuum-insulated glazing unit (10) of the present invention is closed with a hermetically bonding seal (4) placed on the periphery of the glass panes around said internal space. The said hermetically bonding seal is impermeable and hard. Such as used here and unless otherwise indicated, the term “impermeable” is understood to mean impermeable to air or any other gas present in the atmosphere.

Various hermetically bonding seal technologies exist. A first type of seal (the most widespread) is a seal based on a solder glass for which the melting point is lower than that of the glass of the glass panes of the glazing unit. The use of this type of seal limits the choice of low-E layers to those that are not degraded by the thermal cycle required to implement the solder glass, i.e. to those that are able to withstand a temperature possibly as high as 250° C. In addition, since this type of solder-glass-based seal is only very slightly deformable, it does not allow the effects of differential expansion between the interior-side glass pane of the glazing unit and the exterior-side glass pane of the glazing unit when said panes are subjected to large temperature differences to be absorbed. Quite substantial stresses are therefore generated at the periphery of the glazing unit and may lead to breakage of the glass panes of the glazing unit.

A second type of seal comprises a metal seal, for example a metal strip of a small thickness (<500 μm) soldered to the periphery of the glazing unit by way of a tie underlayer covered at least partially with a layer of a solderable material such as a soft tin-alloy solder. One substantial advantage of this second type of seal relative to the first type of seal is that it is able to partially deform in order to partially absorb the differential expansion created between the two glass panes. There are various types of tie underlayers on the glass pane.

Patent application WO 2011/061208 A1 describes one example embodiment of a peripheral impermeable seal of the second type for a vacuum-insulated glazing unit. In this embodiment, the seal is a metal strip, for example made of copper that is soldered by means of a solderable material to an adhesion band provided on the periphery of the glass panes.

### Internal Volume

A vacuum of absolute pressure less than 0.1 mbar, preferably less than 0.01 mbar is created, within the internal volume, V, defined by the first and second glass panes and the set of discrete spacers and closed by the hermetically bonding seal within the laminated VIG of the present invention.

The internal volume of the laminated VIG of the present invention, can comprise a gas, for example, but not exclusively, air, dry air, argon (Ar), krypton (Kr), xenon (Xe), sulfur hexafluoride (SF 6), carbon dioxide or a combination thereof. The transfer of energy through an insulating pane having this conventional structure is decreased, because of the presence of the gas in the internal volume, relative to a single glass pane.

The internal volume may also be pumped of any gas, creating therefore a vacuum glazing unit. Energy transfer through a vacuum-insulated insulating glazing unit is greatly decreased by the vacuum. To generate the vacuum in the internal space of the glazing unit, a hollow glass tube bringing the internal space into communication with the exterior is generally provided on the main face of one of the glass panes. Thus, the partial vacuum is generated in the internal space by pumping out gases present in the internal space by virtue of a pump connected to the exterior end of the glass tube.

To maintain for the duration a given vacuum level in a vacuum-insulated glazing unit a getter may be used in the glazing unit. Specifically, the internal surfaces of the glass panes making up the glazing unit may release over time gases absorbed beforehand in the glass, thereby increasing the internal pressure in the vacuum-insulated glazing pane and thus decreasing the vacuum performance. Generally, such a getter consists of alloys of zirconium, vanadium, iron, cobalt, aluminum, etc., and is deposited in the form of a thin layer (a few microns in thickness) or in the form of a block placed between the glass panes of the glazing pane so as not to be seen (for example hidden by an exterior enamel or by a portion of the peripheral impermeable seal). The getter forms, on its surface, a passivation layer at room temperature, and must therefore be heated in order to make the passivation layer disappear and thus activate its alloy gettering properties. The getter is said to be “heat activated”.

The person skilled in the art realizes that the present invention by no means is limited to the preferred embodiments described above. On the contrary, many modifications and variations are possible within the scope of the appended claims. It is further noted that the invention relates to all possible combinations of features, and preferred features, described herein and recited in the claims.

The following examples are provided for illustrative purposes, and are not intended to limit the scope of this invention.

### EXAMPLES

Examples 1 to 7 illustrate different embodiments of laminated VIGs of the present invention, demonstrating high resistance to thermal induced stress while meeting the safety and security requirements. The thermal induced stress is calculated by an analytical linear solution at the conditions below and is the highest value obtained for the first and second glass panes.
Temperature: ΔT=30° C. AT is calculated as the temperature difference between the mean temperature of the first glass pane, T1, and the mean temperature of the second glass pane, T2;
Glass panes are float annealed glass panes with a Young's modulus, E=72 GPa and a Poisson's ratio, μ=0.21; and
Unconstraint edges, i.e. not positioned within a window frame
In the examples wherein the thickness of the first glass pane is greater than the thickness of the second glass plane (Z1>Z2), then the thermal induced stress is calculated in the configuration wherein the first glass pane faces the lower environment temperature T1 (T1<T2).

To form a double glazing unit, the outer pane face of the second glass pane of the laminated VIG of example 1 can be further coupled to a third glass pane along the periphery of the vacuum insulating glazing unit via a peripheral spacer bar, creating an insulating cavity sealed by a peripheral edge seal.

| | | | |
|---|---|---|---|
| Example 1 | Example 2 | Example 3 | Example 4 |

VIG Structure

| | | | | | |
|---|---|---|---|---|---|
| First glass pane | CET | 86 10⁻⁷/° C. | 87 10⁻⁷/° C. | 88 10⁻⁷/° C. | 88 10⁻⁷/° C. |
| Soda lime silica glass | Thickness | Z1 = 4 mm | Z1 = 6 mm | Z1 = 31 mm* | Z1 = 6 mm |
| ClearLight ™ from AGC | Length | L = 1000 mm | L = 1200 mm | L = 1500 mm | L = 1200 mm |
| Second glass pane | CET | 86 10⁻⁷/° C. | 87 10⁻⁷/° C. | 88 10⁻⁷/° C. | 88 10⁻⁷/° C. |
| Soda lime silica glass | Thickness | Z2 = 4 mm | Z2 = 4 mm | Z2 = 3 mm* | Z2 = 4 mm |
| ClearLight ™ from AGC | Length | L = 1000 mm | L = 1200 mm | L = 1500 mm | L = 1200 mm |

| | | | | |
|---|---|---|---|---|
| Ra = max (Z1/Z2, Z2/Z1) | 1 | 1.5 | 1 | 1.5 |
| Thermal induced stress of the VIG | 5.92 MPa | 2.90 MPa | 6.06 MPa | 2.94 MPa |

Laminated assembly to the first glass pane

| | | | | | |
|---|---|---|---|---|---|
| Laminated glass sheet | Thickness | Zsₐ = 6 mm | Zsₐ = 4 mm | Zsₐ = 3mm | — |
| Polymer interlayer | Thickness | 0.76 mm | 0.38 mm | 0.38 mm | — |
| | Comp. | EVA | PVB | EVA | — |

Laminated assembly to the second glass pane

| | | | | | |
|---|---|---|---|---|---|
| Laminated glass sheet | | — | Zs_{b} = 4 mm | Zs_{b} = 4 mm | Zs_{b} = 3 mm |
| Polymer interlayer | Thickness | — | 0.38 mm | 0.38 mm | 1.52 mm |
| | Comp. | — | Acoustic PVB | EVA | PVB |

| | | | | |
|---|---|---|---|---|
| Zmax-Equation A | 10.2 mm | 11.6 mm | 7.7 mm | 11.6 mm |
| 1.25 Zopt-Equation B | 7.8 mm | 9.5 mm | 5.9 mm | 9.75 mm |
| Zopt-Equation B | 6.3 mm | 7.6 mm | 4.7 mm | 7.8 mm |
| $\sqrt[3]{{\sum }_{i = 1}^{m + n}} {Zs}_{i}^{3}$ | 6 mm | 5.0 mm | 4.5 mm | 3 mm |
| Thermal induced stress laminated VIG | 0.70 MPa | 0.97 Mpa | 0.73 Mpa | 2.48 MPa |

*The first and second glass panes of example 3 are both thermally toughened.

| | | |
|---|---|---|
| Example 5 | Example 6 | Example 7 |

VIG Structure

| | | | | |
|---|---|---|---|---|
| First glass pane | CET | 87 10⁻⁷/° C. | 87 10⁻⁷/° C. | 87 10⁻⁷/° C. |
| Soda lime silica glass | Thickness | Z1 = 6 mm | Z1 = 4 mm | Z1 = 10 mm |
| ClearLight ™ from AGC | Length | L = 1600 mm | L = 1000 mm | L = 2400 mm |
| Second glass pane | CET | 87 10⁻⁷/° C. | 87 10⁻⁷/° C. | 87 10⁻⁷/° C. |
| Soda lime silica glass | Thickness | Z2 = 6 mm | Z2 = 4 mm | Z2 = 8 mm |
| ClearLight ™ from AGC | Length | L = 1600 mm | L = 1000 mm | L = 2400 mm |

| | | | |
|---|---|---|---|
| Ra = max (Z1/Z2, Z2/Z1) | 1 | 1 | 1.25 |
| Thermal induced stress of the VIG | 5.99 MPa | 5.99 MPa | 4.50 MPa |

Laminated assembly to the first glass pane

| | | | | |
|---|---|---|---|---|
| Laminated glass sheet | Thickness | Zsₐ = 15 mm | Zsₐ = 1 mm | Zsₐ = 6 mm |
| Polymer interlayer | Thickness | 1.27 mm | 0.38 mm | 0.76 mm |
| | Comp. | PU | PVB | EVA |

Laminated assembly to the second glass pane

| | | | | |
|---|---|---|---|---|
| Laminated glass sheet | Thickness | — | Zs_{b} = 6 mm | Zs_{b} = 4 mm |
| Polymer interlayer | Thickness | — | 2.28 mm | 0.76 mm |
| | Comp. | — | PVB | EVA |
| Second laminated glass sheet | | — | Zs_{c} = 6 mm | — |
| Second polymer | Thickness | — | 0.76 mm | — |
| interlayer | Comp. | — | PVB | — |

| | | | |
|---|---|---|---|
| Zmax-Equation A | 15.3 mm | 10.2 mm | 21.9 mm |
| 1.25 Zopt-Equation B | 12.0 mm | 7.9 mm | 17.6 mm |
| Z Opt-Equation B | 9.6 mm | 6.3 mm | 14.1 mm |
| $\sqrt[3]{{\sum }_{i = 1}^{m + n}} {Zs}_{i}^{3}$ | 15 mm | 7.6 mm | 6.5 mm |
| Thermal induced stress laminated VIG | 5.81 MPa | 2.17 MPa | 3.69 MPa |

| Ref.# | Feature |
|---|---|
| 10 | Vacuum-insulated glazing |
| 1 | First glass pane |
| 11 | Inner pane face of the first glass pane |
| 12 | Outer pane face of the first glass pane |
| 2 | Second glass pane |
| 21 | Inner pane face of the second glass pane |
| 22 | Outer pane face of the second glass pane |
| 3 | Discrete spacer |
| 4 | Hermetically bonding seal |
| 5 | Glass sheet |
| 6 | Polymer interlayer |
| 7 | Heat ray reflection film or Low emissivity film |
| V | Internal volume |

1: A laminated vacuum insulating assembly extending along a plane, P, defined by a longitudinal axis, X, and a vertical axis, Z, comprising:
a first glass pane having a thickness Z₁, an inner pane face and an outer pane face, and a second glass pane having a thickness, Z₂, an inner pane face and an outer pane face, wherein the thicknesses are measured in a direction normal to the plane, P;
a set of discrete spacers positioned between the first and second glass panes, maintaining a distance between the first and the second glass panes;
a hermetically bonding seal sealing the distance between the first and second glass panes over a perimeter thereof;
an internal volume, V, defined by the first and second glass panes and the set of discrete spacers and closed by the hermetically bonding seal and wherein there is an absolute vacuum of pressure of less than 0.1 mbar, and wherein the inner pane face faces the internal volume, V;
wherein the outer pane face of the first glass pane is laminated to a m glass sheet by a m polymer interlayer to form a laminated assembly; and/or the outer pane face of the second glass pane is laminated to a n glass sheet by a n polymer interlayer to form a laminated assembly; wherein the glass sheet has a sheet thickness, Zs, measured in the direction normal to the pane, P and wherein m is a positive integer greater than or equal to 0 (m≥0), n is a positive integer greater than or equal to 0 (n≥0) and the sum of the m and n integers is greater than or equal to 1 (m+n≥1); and in that a cubic root of the sum of the sheet thicknesses, Zₛ, to the third power is equal to or lower than a maximum thickness value, Zₘₐₓ,
$$( \sqrt[3]{{\sum }_{i = 1}^{m + n} {Zs}_{i}^{3}} \leq {Z}_{max} )$$
wherein Zₘₐₓ is calculated as per Equation A below, expressed in mm:
Zₘₐₓ=5.78−3.4Rₐ−0.57(Rₐ−1.68)²+1.1(Z₁+Z₂)−0.26[(Z₁+Z₂)−12][Rₐ−1.68] (Equation A),
wherein Rₐ is a maximum value between a thickness ratio of the thickness of the first glass pane to the thickness of the second glass pane, Z₁/Z₂, and a thickness ratio of the thickness of the second glass pane to the thickness of the first glass pane, Z₂/Z₁.

2: The laminated vacuum insulating assembly according to claim 1, wherein the cubic root of the sum of the sheet thicknesses, Zₛ, to the third power, is equal to or lower than 125% of an optimum thickness value, Zₒₚₜ,
$$( \sqrt[3]{{\sum }_{i = 1}^{m + n} Z {s}_{i}^{3}} \leq 1.25 {Z}_{opt} ) ,$$
wherein Zₒₚₜ is calculated as per Equation B below, expressed in mm:
Zₒₚₜ=2.54−1.42Rₐ−0.625(Rₐ−1.68)²+0.73(Z₁+Z₂)−0.12[(Z₁+Z₂)−12][Rₐ−1.68] (Equation B).

3: The laminated vacuum insulating assembly according to claim 1, wherein the cubic root of the sum of the sheet thicknesses, Zₛ, to the third power, is equal to or greater than 2 mm
$$( \sqrt[3]{{\sum }_{i = 1}^{m + n} Z {s}_{i}^{3}} \geq 2 mm ) ,$$

4: The laminated vacuum insulating assembly according to claim 2, wherein the cubic root of the sum of the sheet thicknesses, Zₛ, to the third power, is equal to or greater than 40% of an optimum thickness value, Zₛ,
$$( \sqrt[3]{{\sum }_{i = 1}^{m + n} Z {s}_{i}^{3}} \geq 0.4 {Z}_{opt} ) ,$$

5: The laminated vacuum insulating glazing according to claim 2, wherein the cubic root of the sum of the sheet thicknesses, Zₛ, to the third power, is between 80% and 125% of the optimum thickness value, Zₒₚₜ:
$$0.8 {Z}_{opt} \leq \sqrt[3]{{\sum }_{i = 1}^{m + n} Z {s}_{i}^{3}} \leq 1.25 {Z}_{opt} .$$

6: The laminated vacuum insulating assembly according to claim 1, wherein the first glass pane has a coefficient of linear thermal expansion, CTE₁, and the second glass pane has a coefficient of linear thermal expansion, CTE₂, wherein an absolute difference between CTE₁ CTE₂ is at most 1.2 10⁻⁶/° C. (|CTE₁−CTE₂|≤1.2 10⁻⁶/° C.).

7: The A laminated vacuum insulating assembly according to claim 1, wherein m+n equals 2.

8: The laminated vacuum insulating assembly according to claim 1, wherein m equals 0.

9: The laminated vacuum insulating assembly according to claim 1, wherein Z₁ is greater than Z₂.

10: The laminated vacuum insulating assembly according to claim 9, wherein a thickness ratio, Z₁/Z₂, is equal to or greater than 1.10 (Z₁/Z₂≥1.10).

11: The laminated vacuum insulating assembly according to claim 1, having a length, L, measured along the vertical axis, Z, wherein the length is equal to or greater than 500 mm, (L≥500 mm).

12: The laminated vacuum insulating assembly according to claim 1, having a width, W, measured along the longitudinal axis, X, wherein the width is equal to or greater than 300 mm, (W≥300 mm).

13: The laminated vacuum insulating assembly according to claim 1, wherein the polymer interlayer comprises a material selected from the group consisting of ethylene vinyl acetate, polyisobutylene, polyvinyl butyral, polyurethane, polyvinyl chlorides, polyesters, copolyesters, polyacetals, cyclo olefin polymers, ionomer, and an ultraviolet activated adhesive and combinations thereof.

14. (canceled)

15. (canceled)

16: The laminated vacuum insulating assembly according to claim 1, wherein the cubic root of the sum of the sheet thicknesses, Zₛ, to the third power, is equal to or lower than the optimum thickness value, Zₒₚₜ,
$$( \sqrt[3]{{\sum }_{i = 1}^{m + n} Z {s}_{i}^{3}} \leq {Z}_{opt} ) ,$$
wherein Zₒₚₜ is calculated as per Equation B below, expressed in mm:
Zₒₚₜ=2.54−1.42Rₐ−0.625(Rₐ−1.68)²+0.73(Z₁+Z₂)−0.12[(Z₁+Z₂)−12][Rₐ−1.68] (Equation B).

17: The laminated vacuum insulating assembly according to claim 1, wherein the cubic root of the sum of the sheet thicknesses, Zₛ, to the third power, is equal to or greater than 3 mm
$$( \sqrt[3]{{\sum }_{i = 1}^{m + n} Z {s}_{i}^{3}} \geq 3 mm ) .$$

18: The laminated vacuum insulating assembly according to claim 2, wherein the cubic root of the sum of the sheet thicknesses, Zₛ, to the third power, is equal to or greater than 80% of an optimum thickness value, Zₒₚₜ,
$$( \sqrt[3]{{\sum }_{i = 1}^{m + n} Z {s}_{i}^{3}} \geq 0.80 {Z}_{opt} .$$

19: The laminated vacuum insulating glazing according to claim 4, wherein the cubic root of the sum of the sheet thicknesses, Zₛ, to the third power, is between 80% and 125% of the optimum thickness value, Zₒₚₜ:
$$0.8 {Z}_{opt} \leq \sqrt[3]{{\sum }_{i = 1}^{m + n} Z {s}_{i}^{3}} \leq 1.25 {Z}_{opt} .$$

20: The laminated vacuum insulating assembly according to claim 1, wherein the first glass pane has a coefficient of linear thermal expansion, CTE₁, and the second glass pane has a coefficient of linear thermal expansion, CTE₂, wherein an absolute difference between CTE₁ and CTE₂ is at most 0.8 10⁻⁶/° C. (|CTE₁−CTE₂|≤0.8 10⁻⁶/° C.).

21: The laminated vacuum insulating assembly according to claim 1, wherein m+n equals 1.

22: The laminated vacuum insulating assembly according to claim 9, wherein a thickness ratio, Z₁/Z₂, is comprised between 1.60 and 6.00 (1.60≤Z₁/Z₂≥6.00).
